(19) United States
(12) Patent Application Publication
(10) Pub. No.: US 2026/0112188 A1
(43) Pub. Date: Apr. 23, 2026

(54) INFORMATION PROCESSING SYSTEM AND CONTROL METHOD FOR INFORMATION PROCESSING SYSTEM

(71) Applicant: Toshiba Tec Kabushiki Kaisha, Tokyo (JP)

(72) Inventor: Takahiro SASAKI, Sunto Shizuoka (JP)

(21) Appl. No.: 19/290,018

(22) Filed: Aug. 4, 2025

(30) Foreign Application Priority Data
Oct. 18, 2024 (JP) 2024-184180

(51) Int. Cl. G06V 30/12; G06T 11/60; G06V 10/776; G06V 10/94; G06V 10/96; G06V 10/98; G06V 30/262

(52) U.S. Cl. CPC G06V 30/127; G06T 11/60; G06V 10/776; G06V 10/95; G06V 10/96; G06V 10/987; G06V 30/262; G06T 2200/24

(57) ABSTRACT

According to one embodiment, an information processing system includes a receiving unit, an OCR execution unit, a management unit, an extraction unit, a correction candidate output unit, an accuracy information output unit, and a correction acceptance unit. The receiving unit receives image information. The OCR execution unit performs character recognition on the image information using OCR. The management unit stores definition data that defines a workflow based on the image information. The extraction unit extracts a usage item handled in the workflow from the definition data. The correction candidate output unit extracts a value corresponding to the usage item from a recognition result obtained by the OCR execution unit and outputs the value as a correction candidate. The accuracy information output unit outputs information based on accuracy when the OCR execution unit recognizes the correction candidate. The correction acceptance unit accepts a correction for the correction candidate.

### CROSS-REFERENCE TO RELATED APPLICATION

This application is based upon and claims the benefit of priority from Japanese Patent Application No. 2024-184180, filed Oct. 18, 2024, the entire contents of which are incorporated herein by reference.

### FIELD

Embodiments described herein relate generally to an information processing system and a control method for the information processing system.

### BACKGROUND

In order to perform processing using results of optical character recognition (OCR), devices, systems, methods, and programs are known that determine the type of text information being extracted by OCR and then perform processing according to the determined type. However, if the user is required to confirm and correct even just some of the data to check whether the results of OCR are correct, then the amount of work required of the user increases, which is inconvenient to the user.

### BRIEF DESCRIPTION OF THE DRAWINGS

FIG. 1 is a block diagram of an information management system including an information processing system according to an embodiment.

FIG. 2 is a block diagram of a processing server.

FIG. 3 is a block diagram of a file server.

FIG. 4 is a block diagram of an OCR server.

FIG. 5 is a block diagram illustrating functional units of an information processing system.

FIG. 6 is a flowchart illustrating a workflow setting operation in an information processing system.

FIG. 7 depicts an example of a usage item list used in an information processing system.

FIG. 8 is a flowchart illustrating a workflow executing operation in an information processing system.

FIG. 9 is a diagram illustrating an example of a screen displayed on a user terminal by an information processing system.

### DETAILED DESCRIPTION

An embodiment described herein provides an information processing system and a control method for the information processing system involving OCR that reduces the amount of work required of the user.

In general, according to one embodiment, an information processing system includes a receiving unit configured to receive image information corresponding to a document from a user terminal; an OCR execution unit configured to perform character recognition on the image information using optical character recognition (OCR); a management unit configured to store definition data that defines a workflow associated with the image information; an extraction unit configured to extract a usage item from the definition data of the workflow; a correction candidate output unit configured to extract a value corresponding to the usage item from a recognition result from the OCR execution unit and output the value as a correction candidate; an accuracy information output unit configured to output information based on a recognition accuracy for the correction candidate; and a correction acceptance unit configured to receive a correction of the correction candidate from a user.

Hereinafter, certain example embodiments will be described with reference to the drawings. In the following description, components having substantially the same functions and configurations are denoted by the same reference symbols. In addition, the example embodiments described below are merely illustrative of the technical ideas and concepts of the present disclosure. The present disclosure is not necessarily limited to the specific materials, shapes, structures, and arrangements of components in these examples. The embodiments can be modified in various ways and still be within the scope of the present disclosure.

### <Configuration>

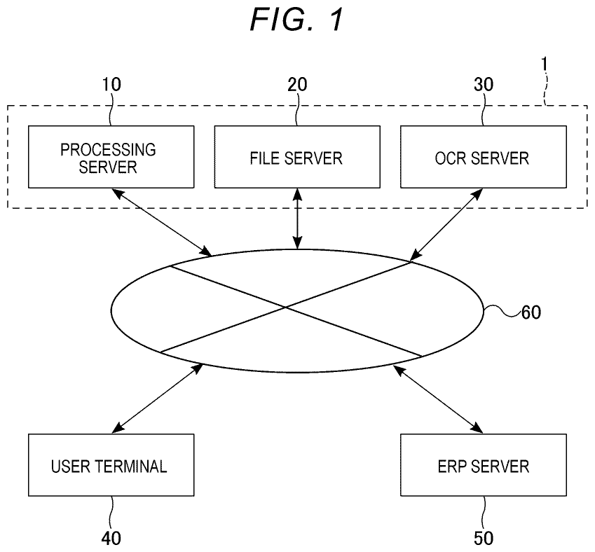

FIG. 1 is a block diagram illustrating an example of a configuration of an information management system including an information processing system according to an embodiment. The information management system manages information about documents such as slips of paper, receipts, invoices, bills, notes, or the like. The information management system includes an information processing system 1, a user terminal 40, and an enterprise resource planning (ERP) server 50. Each of the information processing system 1, the user terminal 40, and the ERP server 50 is connected to a network 60.

The information processing system 1 is a system that, upon receiving image information of a document from a user, attempts to recognize characters on the document using OCR processing. The system asks the user to confirm the recognition result, and then registers (stores) the recognition result in the ERP server. The information processing system 1 includes a processing server 10, a file server 20, and an OCR server 30. The processing server 10 controls an overall operation of the information processing system 1. The file server 20 stores information (e.g., files). The OCR server executes OCR processing to recognize character (text) information in image data. Each of the processing server 10, the file server 20, and the OCR server 30 is connected to the network 60.

The user terminal 40 is, for example, an information processing terminal such as a personal computer (PC), a tablet, or a smartphone. The user operates the user terminal 40 to exchange information with the information processing system 1.

The ERP server 50 executes enterprise resource planning software.

The network 60 is a communication path formed by a single network or a combination of networks, for example, a wired or wireless local area network (LAN), the Internet, a telephone communication network, and the like

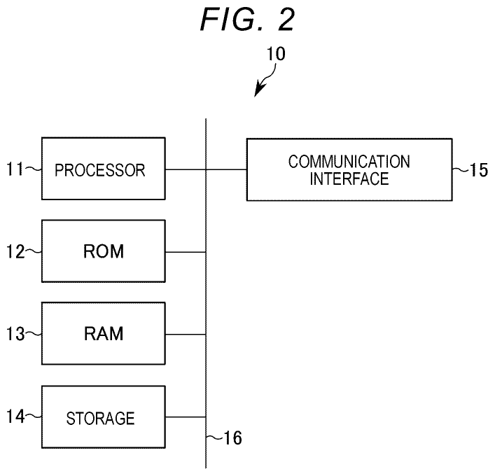

FIG. 2 is a block diagram illustrating an example of a configuration of the processing server according to the embodiment. The processing server 10 includes a processor 11, a read only memory (ROM) 12, a random access memory (RAM) 13, a storage 14, a communication interface 15, and a system bus 16. The system bus 16 comprises an address bus, a data bus, a control signal line, and the like. The system bus 16 connects the processor 11, the ROM 12, the RAM 13, the storage 14, and the communication interface 15 to each other. The processor 11, the ROM 12, the RAM 13, and the storage 14 are connected to each other by the system bus 16.

The processor 11 controls each of portions to implement various functions of the processing server 10 according to an operating system or an application program. The processor 11 is, for example, a central processing unit (CPU).

The ROM 12 is a non-volatile storage device. The ROM 12 stores a preset operating system or application program, control data, and the like.

The RAM 13 is a volatile storage device. The RAM 13 is used as a work area where data can be appropriately rewritten by the processor 11. The RAM 13 is also used as a buffer memory for temporarily storing data.

The storage 14 is an auxiliary unit or the like. The storage 14 stores data used by the processor 11 in performing various kinds of processing or data generated by the processing in the processor 11. The storage 14 may also store the application program described above. The storage 14 is, for example, an EEPROM (Electric Erasable Programmable Read Only Memory), an HDD (Hard Disk Drive), or an SSD (Solid State Drive).

The communication interface 15 is an interface for communicating with other devices connected to a network. The communication interface 15 is used for communication with external devices. In this context, external devices include, for example, the file server 20, the OCR server 30, the user terminal 40, and the ERP server 50. The communication interface 15 has a LAN connector or the like, for example. The communication interface 15 may wirelessly communicate with other devices according to a communication standard such as Wi-fi.

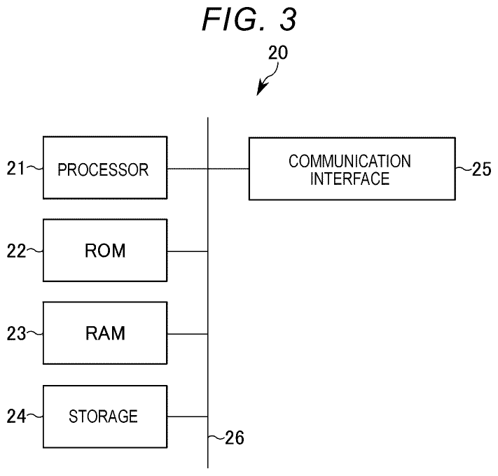

FIG. 3 is a block diagram illustrating an example of a configuration of the file server according to the embodiment. The file server 20 includes a processor 21, a ROM 22, a RAM 23, a storage 24, a communication interface 25, and a system bus 26. The system bus 26 includes an address bus, a data bus, a control signal line, and the like. The system bus 26 connects the processor 21, the ROM 22, the RAM 23, the storage 24, and the communication interface 25 to each other. The processor 21, the ROM 22, the RAM 23, and the storage 24 are connected to each other by the system bus 26.

The processor 21 controls each of portions to implement various functions of the file server 20 according to an operating system and/or an application program. The processor 21 is, for example, a CPU.

The ROM 22 is a non-volatile storage device. The ROM 22 stores a preset operating system and/or application program, control data, and the like.

The RAM 23 is a volatile storage device. The RAM 23 is used as a work area where data can be appropriately rewritten by the processor 21. The RAM 23 is also used as a buffer memory for temporarily storing data.

The storage 24 is an auxiliary storage unit or the like. The storage 24 stores data used by the processor 21 in performing various kinds of processing or data generated by the processing in the processor 21. The storage 24 may also store the application program described above. The storage 24 is, for example, an EEPROM, an HDD, or an SSD.

The communication interface 25 is an interface for communicating with other devices connected via a network. The communication interface 25 is used for communication with external devices. In this context, external devices include, for example, the processing server 10, the OCR server 30, the user terminal 40, and the ERP server 50. The communication interface 25 is configured with a LAN connector or the like, for example. The communication interface 25 may wirelessly communicate with other devices according to a communication standard such as Wi-fi.

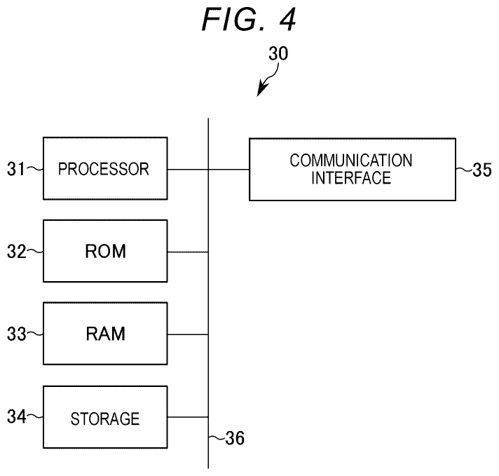

FIG. 4 is a block diagram illustrating an example of a configuration of the OCR server according to the embodiment. The OCR server 30 includes a processor 31, a ROM 32, a RAM 33, a storage 34, a communication interface 35, and a system bus 36. The system bus 36 includes an address bus, a data bus, a control signal line, and the like. The system bus 36 connects the processor 31, the ROM 32, the RAM 33, the storage 34, and the communication interface 35 to each other. The processor 31, the ROM 32, the RAM 33, and the storage 34 are connected to each other by the system bus 36.

The processor 31 implements various functions of the OCR server 30 according to an operating system and/or an application program. The processor 31 is, for example, a CPU.

The ROM 32 is a non-volatile storage device. The ROM 32 stores a preset operating system and/or application program, control data, and the like.

The RAM 33 is a volatile storage device. The RAM 33 is used as a work area where data can be appropriately rewritten by the processor 31. The RAM 33 is also used as a buffer memory for temporarily storing data.

The storage 34 is an auxiliary storage unit or the like. The storage 34 stores data used by the processor 31 in performing various kinds of processing or data generated by the processing in the processor 31. The storage 34 may also store the application program described above. The storage 34 is, for example, an EEPROM, an HDD, or an SSD.

The communication interface 35 is an interface for communicating with other devices connected via a network. The communication interface 35 is used for communication with external devices. In this context, external devices include, for example, the processing server 10, the file server 20, the user terminal 40, and the ERP server 50. The communication interface 35 is configured with a LAN connector or the like, for example. The communication interface 35 may wirelessly communicate with other devices according to a communication standard such as Wi-fi.

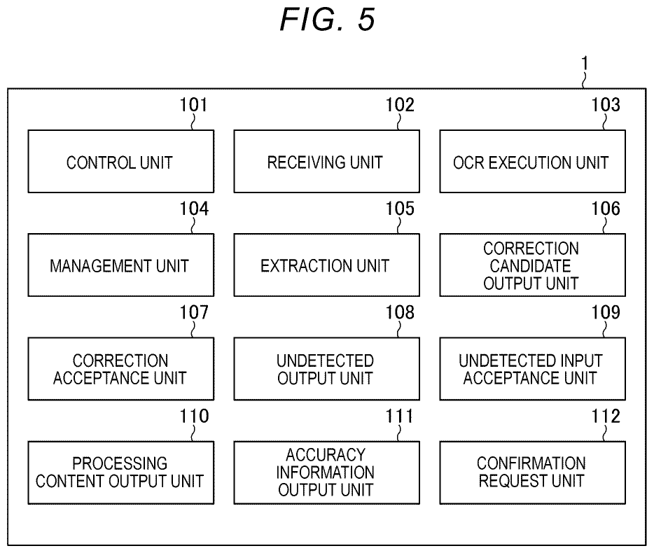

FIG. 5 is a block diagram illustrating an example of functional units in the information processing system according to the embodiment. The various functions of the information processing system 1 can also be expressed as the set of functional units illustrated in FIG. 5. The information processing system 1 includes a control unit 101, a receiving unit 102, an OCR execution unit 103, a management unit 104, an extraction unit 105, a correction candidate output unit 106, a correction acceptance unit 107, an undetected output unit 108, an undetected input acceptance unit 109, a processing content output unit 110, an accuracy information output unit 111, and a confirmation request unit 112.

The control unit 101 controls the overall operation of the information processing system 1. The functions of the control unit 101 are implemented when the processor 11 of the processing server 10 executes the application program stored in the ROM 12 or the storage 14, for example.

The receiving unit 102 receives image information from the user terminal 40 and stores the received image information. The functions of the receiving unit 102 are implemented when the processor 21 of the file server 20 controls the communication interface 25 to receive image information and the storage 24 to store the received image information.

The OCR execution unit 103 executes OCR processing on the image information stored in the file server 20, and obtains a recognition result. The recognition result includes an accuracy value or measure indicating how accurate the recognition result is considered. For example, the OCR execution unit 103 extracts keywords and values corresponding to the keywords from the image information using an artificial intelligence (AI) technology. The function of the OCR execution unit 103 is implemented when the processor 31 of the OCR server 30 controls the communication interface 35 to receive the image information from the file server 20 and executes the application program stored in the ROM 32 or the storage 34 to perform OCR processing, for example.

The management unit 104 stores definition data that defines a workflow of a series of processes based on the received image information. The function of the management unit 104 is implemented when the processor 11 of the processing server 10 controls the storage 14 to store the definition data, for example.

The extraction unit 105 extracts usage items to be handled in the workflow from the definition data stored in the management unit 104. The function of the extraction unit 105 is implemented when the processor 11 of the processing server 10 executes the application program stored in the ROM 12 or the storage 14, for example.

The correction candidate output unit 106 extracts, from the recognition result obtained by the OCR execution unit 103, values corresponding to the usage items obtained by the extraction unit 105, and outputs these values as correction candidates. The function of the correction candidate output unit 106 is implemented when the processor 11 of the processing server 10 executes the application program stored in the ROM 12 or the storage 14, for example.

The correction acceptance unit 107 accepts user corrections of the correction candidates. The function of the correction acceptance unit 107 is implemented when the processor 11 of the processing server 10 executes the application program stored in the ROM 12 or the storage 14 and receives a correction command via the communication interface 15, for example.

The undetected output unit 108 outputs, as undetected items, those items in the usage items obtained by the extraction unit 105 not included in the recognition result obtained by the OCR execution unit 103. The function of the undetected output unit 108 is implemented when the processor 11 of the processing server 10 executes the application program stored in the ROM 12 or the storage 14, for example.

The undetected input acceptance unit 109 accepts an input from the user regarding the undetected items obtained by the undetected output unit 108. The function of the undetected input acceptance unit 109 is implemented when the processor 11 of the processing server 10 executes the application program stored in the ROM 12 or the storage 14 and receives an input command via the communication interface 15, for example.

The processing content output unit 110 outputs processing content indicators indicating how the usage items obtained by the extraction unit 105 are to be used in the workflow. The function of the processing content output unit 110 is implemented when the processor 11 of the processing server 10 executes the application program stored in the ROM 12 or the storage 14, for example.

The accuracy information output unit 111 outputs information based on the accuracy when the OCR execution unit 103 recognizes a correction candidate in the recognition result obtained by the OCR execution unit 103. The function of the accuracy information output unit 111 is implemented when the processor 11 of the processing server 10 executes the application program stored in the ROM 12 or the storage 14, for example.

The confirmation request unit 112 outputs a request to input that a correction candidate has been confirmed, based on the accuracy when the OCR execution unit 103 recognizes the correction candidate. The function of the confirmation request unit 112 is implemented when the processor 11 of the processing server 10 executes the application program stored in the ROM 12 or the storage 14, for example.

### <Operation>

The information processing system 1 according to the embodiment performs a workflow setting operation and a workflow executing operation. The workflow setting operation and the workflow executing operation in the information processing system 1 will be described below.

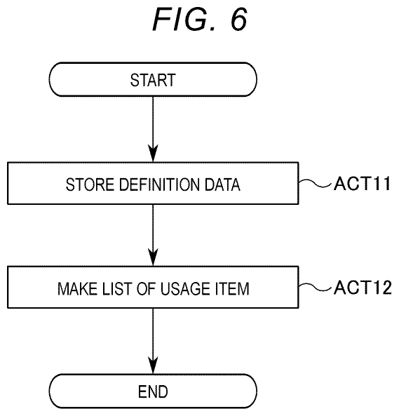

FIG. 6 is a flowchart illustrating the workflow setting operation in the information processing system 1 according to the embodiment. When a user operates the user terminal 40 to set up a workflow (START), the information processing system 1 stores definition data (ACT11). In particular, the management unit 104 of the information processing system 1 stores definition data that defines a workflow based on settings input via the user terminal 40 by the user.

The information processing system 1 makes a list of usage items (ACT12). In particular, the extraction unit 105 of the information processing system 1 extracts, from the definition data, the usage items to be handled in the workflow that has been defined by the definition data, and stores these usage items as a usage item list.

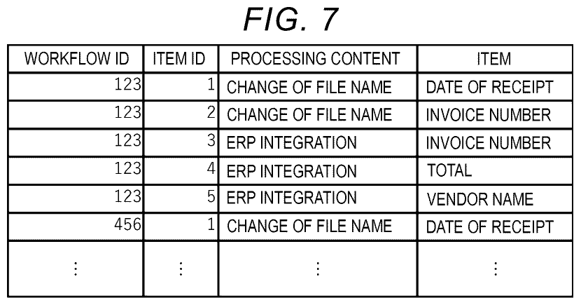

FIG. 7 is a table illustrating an example of a usage item list as used in the information processing system 1 according to the embodiment. As illustrated in FIG. 7, the usage item list records a workflow ID, an item ID, a processing content, and an item. The workflow ID entry is an identification number for identifying the particular definition data. The item ID entry can be a serial (indexing) number of the item being handled in the workflow. The processing content entry indicates what processing is to be performed using a value of an item obtained in the workflow. The item entry indicates an item type or the like handled in the workflow. In the example illustrated in FIG. 7, five item entries corresponding to a workflow ID “123” are listed. An item entry with the item ID of “1” and a processing content of “change of file name” is “date of receipt”. An item entry with the item ID of “2” and a processing content of “change of file name” is “invoice number”. An item entry with the item ID of “3” and a processing content of “ERP integration” is “invoice number”. An item entry with the item ID of “4” and a processing content of “ERP integration” is “total”. An item entry with the item ID of “5” and a processing content of “ERP integration” is “vendor name”.

Referring back to FIG. 6, the process in ACT12 is completed, and the series of processes illustrated in FIG. 6 is terminated (END).

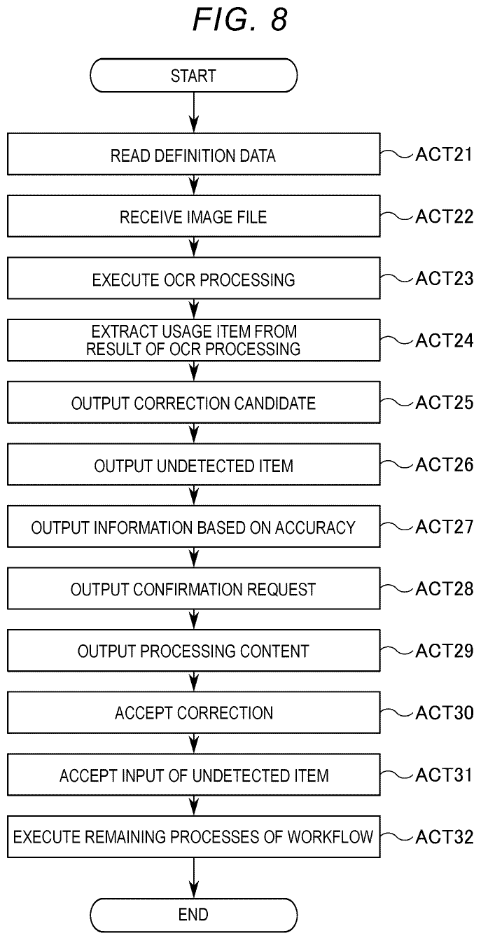

FIG. 8 is a flowchart illustrating a workflow executing operation in the information processing system according to the embodiment. When a user operates the user terminal 40 to command execution of the workflow (START), the information processing system 1 reads out definition data (ACT21). In particular, the management unit 104 of the information processing system 1 reads out definition data of the workflow corresponding to the command executed by the user.

The information processing system 1 receives an image file (ACT22). In particular, the receiving unit 102 of the information processing system 1 receives, from the user terminal 40, the image file used in the workflow.

The information processing system 1 performs OCR processing (ACT23). In particular, the OCR execution unit 103 performs OCR processing on the image file (received in ACT22) and obtains a recognition result.

The information processing system 1 extracts a usage item from the result of the OCR processing (ACT24). In particular, the correction candidate output unit 106 extracts as a correction candidate, from the recognition result obtained in ACT23, a value corresponding to the usage item extracted by the extraction unit 105.

The information processing system 1 outputs the correction candidate (ACT25). In particular, the correction candidate output unit 106 outputs the correction candidate, which was extracted in ACT24, to the user terminal 40. In the present embodiment, the correction candidate output unit 106 outputs the correction candidate and the image file received in ACT22 to the user terminal 40 so as to display the correction candidate and the image file side by side.

The information processing system 1 outputs an undetected item (ACT26). In particular, the undetected output unit 108 outputs, as undetected items, items not included in the recognition result obtained in ACT23, from the usage items extracted by the extraction unit 105, to the user terminal 40.

The information processing system 1 outputs information related to or based on the accuracy (ACT27). In particular, the accuracy information output unit 111 outputs information related to the accuracy obtained when the OCR execution unit 103 recognizes a correction candidate from the recognition result obtained by the OCR execution unit 103. The information related to the accuracy may be an accuracy value itself, a value calculated based on the accuracy, or display information controlled or set based on the accuracy. In the present embodiment, the information related to or based on the accuracy will be a value indicating the accuracy as a percentage and emphasis information for displaying the item in an emphasized manner whenever the accuracy is lower than a first threshold value. The first threshold value cab be any threshold value set for determining that the obtained accuracy at a level lower than that for which it is assumed to require caution or close attention when confirming the value. The first threshold value is, for example, 70%. The emphasis information is, for example, emphasizing the value or the accuracy interposed therebetween with exclamation marks. When outputting the information based on the accuracy, the accuracy information output unit 111 may output prescribed information determined in advance for an undetected item. In the present embodiment, for example, the accuracy of the undetected information is treated as 0%.

The information processing system 1 outputs a confirmation request (ACT28). In particular, the confirmation request unit 112 outputs a confirmation request for an item whose accuracy is lower than a second threshold value. The confirmation request is a request requiring the user to input some indication that the item of concern has been confirmed (checked). The second threshold value can be any threshold value but here it is assumed to be a value for which it is strongly recommended that caution in confirmation be taken. The second threshold value is, for example, 50%. An example of a method of inputting that the user has confirmed includes a method of checking a check box indicating completion of confirmation. The information processing system 1 continues to wait for the user to make corrections or inputs until the check box is checked, and prevents a value from being settled.

The information processing system 1 outputs a processing content indicator (ACT29). In particular, the processing content output unit 110 outputs the processing content indicator to the user terminal 40 indicating how each of the usage items extracted by the extraction unit 105 is to be used in the workflow.

The user terminal 40 prompts the user to confirm whether to correct the correction candidate, what values to input for the undetected item, and to check the check box indicating completion of confirmation, and transmits the results to the information processing system 1.

The information processing system 1 accepts the correction (ACT30). In particular, the correction acceptance unit 107 of the information processing system 1 accepts the correction from the user for the correction candidate output in ACT25 and modifies the value accordingly.

The information processing system 1 accepts the input of the undetected item (ACT31). In particular, the undetected input acceptance unit 109 accepts the input from the user for the undetected item output in ACT26, and updates the value.

The information processing system 1 executes remaining processes of the workflow (ACT32). In particular, the control unit 101 executes any remaining processes that have not yet been executed in the workflow as defined by the definition data that was read in ACT21. For example, in a case of the workflow with a workflow ID “123” illustrated in FIG. 7, a process of “change of file name” and a process of “ERP integration” remain to be performed. The process of “change of file name” is a process for changing the file name of the image file stored in the file server 20. The process of “ERP integration” is a process for transmitting the value of each of the items obtained in the processes from ACT21 to ACT31 in FIG. 8 and the image file on which the process of “change of file name” was performed, to the ERP server 50.

When ACT32 is completed, the series of processes illustrated in FIG. 8 ends (END).

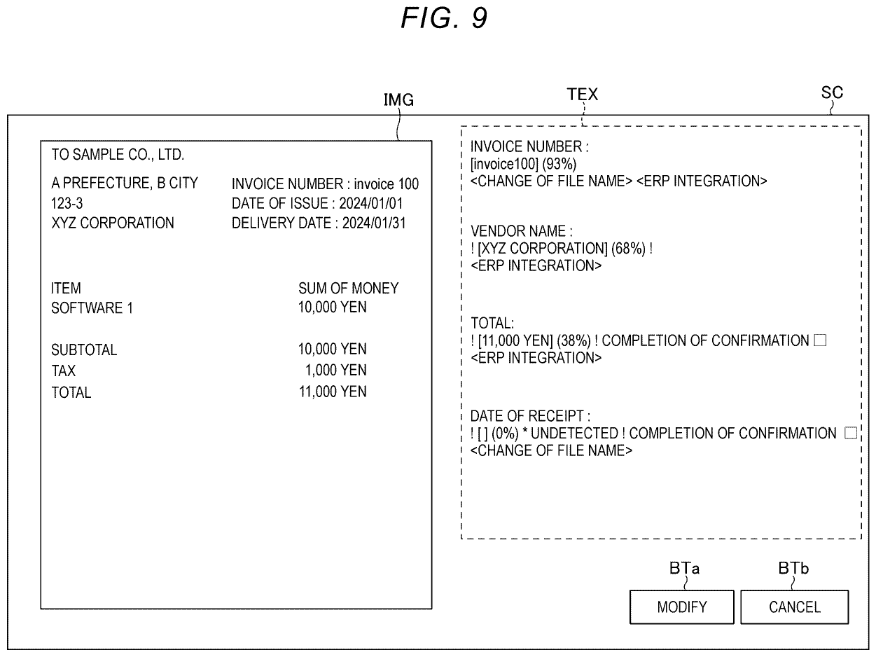

FIG. 9 is a diagram illustrating an example of a screen to be displayed on the user terminal by the information processing system according to an embodiment. As illustrated in FIG. 9, a screen SC includes an image IMG, a confirmation display TEX, a modify button BTa, and a cancel button BTb. The screen SC is displayed on a display of the user terminal 40. The image IMG is a display of the image file used in the workflow, which was transmitted to the information processing system 1 from the user terminal 40. The confirmation display TEX indicates a set of correction candidates and values thereof, an undetected item, accuracy, emphasis information, a confirmation request, and a processing content indicator. In the example illustrated in FIG. 9, items of “invoice number”, “vendor name”, “total”, and “date of receipt” are displayed.

For the item “invoice number”, as an OCR processing result, a value “invoice 100” is obtained with an accuracy of 93%, and the user is prompted to check whether correction is necessary. In addition, for the item “invoice number”, it is also indicated that the item is used in the process of “change of file name” and the process of “ERP integration” in the workflow.

For the item “vendor name”, as an OCR processing result, a value “XYZ Corporation” is obtained with an accuracy of 68%, and the user is prompted to check whether correction is necessary. For the item “vendor name”, since the accuracy is low, the value “XYZ Corporation” and the accuracy of 68% are interposed between exclamation marks, which are emphasis information. In addition, for the item “vendor name”, it is also indicated that the item is used in the process of “ERP integration” in the workflow.

For the item “total”, as an OCR processing result, a value “11,000 yen” is obtained with an accuracy of 38%, and the user is prompted to check whether correction is necessary. For the item “total”, since the accuracy is lower, the value “11,000 yen” and the accuracy of 38% are interposed between exclamation marks, and a check box indicating completion of confirmation is displayed as a confirmation request. In addition, for the item “total”, it is also indicated that the item is used in the process of “ERP integration” in the workflow.

For the item “date of receipt”, an “undetected” value is entered indicating that no value corresponding to this item was detected in the OCR processing result, and a blank is displayed for the user to fill in. Since the accuracy of the item “date of receipt” is 0% and the accuracy is lower, the blank, the accuracy 0%, and the undetected are interposed between exclamation marks. Furthermore, a check box indicating completion of confirmation is displayed, which is a confirmation request. In addition, for the item “date of receipt”, it is also indicated that the item is used in the process of “change of file name” in the workflow. When the user presses the modify button BTa, a process is performed to confirm the correction shown in the confirmation display TEX. When the user presses a cancel button BTb, the execution of the workflow is stopped.

### Effects

In the system including the OCR processing, for example, the user confirms and corrects whether characters have been correctly recognized. For example, when the OCR processing recognizes characters by specifying a plurality of areas, or utilizes an AI technology to extract keywords and values corresponding to the keywords, recognition results may be output for many items. However, if recognition results are output even for items that are not utilized in the current workflow and the user is asked to confirm whether each has been correctly recognized, the burden on the user may increase unnecessarily.

According to an embodiment, the information processing system 1 includes: a receiving unit 102 that receives the image information; an OCR execution unit 103 that performs character recognition on the image information using OCR; a management unit 104 that stores the definition data that defines the workflow to be performed in association with the image information; an extraction unit 105 that extracts from the definition data those usage items handled (used) in the workflow; a correction candidate output unit 106 that extracts the values corresponding to the usage items in the recognition result obtained by the OCR execution unit and outputs the values as correction candidates; an accuracy information output unit 111 that outputs the information based on the accuracy with which the OCR execution unit recognizes a correction candidate; and a correction acceptance unit 107 that accepts the correction for the correction candidates from a user. Accordingly, the information processing system 1 according to an embodiment can be used to confirm and correct the results of an OCR processing while referring to the information based on the accuracy only for the items that are utilized in the workflow. Therefore, the information processing system 1 according to an embodiment can indicate the degree of caution that should be used based on the OCR result accuracy or the like without having the user to confirm any item that is not utilized in the workflow, and this can reduce the workload of the user.

According to an embodiment, the accuracy information output unit 111 outputs the accuracy as a percentage. Accordingly, the information processing system 1 according to the embodiment can appropriately relay the accuracy to the user.

According to an embodiment, the accuracy information output unit 111 outputs emphasis information to emphasize a correction candidate when the accuracy is lower than a first threshold value. Accordingly, the information processing system 1 can urge the user to take notice of an item having low accuracy.

According to an embodiment, the confirmation request unit 112 outputs a confirmation request when the accuracy is lower than a second threshold value so the user will have to input confirmation that the correction candidate has been confirmed (checked). Accordingly, the information processing system 1 can prevent the user from proceeding with a workflow without confirming (checking) an item that has lower accuracy.

According to an embodiment, the OCR execution unit 103 extracts keywords and values corresponding to the keywords from the image information using AI technology. In this way, when the AI technology is used in OCR processing, it is possible to recognize many items without specifying an area (field) in advance, as compared to standard OCR processing in which an area of an image has to be specified in advance and all characters are recognized, for example. In other words, it is possible to reduce issues involved in the OCR processing by utilization of AI technology. The amount of confirmation and correction work required by the user may increase as the number of recognizable items increases, but according to the embodiment, the user is prompted to confirm the result of the OCR processing only for items that are utilized in the workflow and for which accuracy information indicates is necessary. Therefore, according to an embodiment, even when the AI technology is used in the OCR processing, it is possible to prevent an increase in the amount of confirmation and correction work required by the user. In this way, the OCR processing using the AI technology becomes more suitable as the OCR processing used in an embodiment.

### Other Modifications

In an embodiment, the information based on the accuracy output from the accuracy information output unit 111 has been described using, as examples, a value indicating the accuracy as a percentage and emphasis information for displaying the item in an emphasized manner when the accuracy is lower than a first threshold value. The information based on the accuracy is not limited thereto. For example, the accuracy may be expressed as a numerical value in a range of 0.00 to 1.00, or may be expressed as a large number or a small number within any range. For example, symbols such as ∘, Δ, and x may be displayed based on the accuracy, or the color of the font or the like may change from blue to red based on the accuracy. In this way, the information based on the accuracy is not limited to the numerical values, and can be expressed in various ways such as figures, icons, and colors. The emphasis information is also not limited to switching between two states based on a single threshold value, and any number of states or gradations may be adopted depending on the accuracy value(s). Furthermore, the emphasis information may be displayed not only by the exclamation marks, but also by various ways including changing the size of the characters, changing the color or the characters or figures, changing the background color of the relevant item, or surrounding the relevant item with a frame, for example.

In an embodiment, a case in which checking a check box indicating completion of confirmation has been described as an example of a confirmation request method. The confirmation request method is not limited to such a case. For example, a button indicating completion of confirmation may be displayed on a screen, and the confirmation may be recognized when this button is pressed. In some examples, the completion of confirmation may be automatically determined by detection of an input or editing of the relevant item.

In an embodiment, a case has been described in which the function of the OCR execution unit 103 is implemented when the processor 31 executes an application program to perform the OCR processing. The OCR server 30 may include a component other than the processor 31 that performs a calculation, and the OCR processing may be executed by hardware other than the processor 31. For example, the OCR server 30 may further include an AI calculation unit that is a calculation unit specialized for processing utilizing AI technology, and the function of the OCR execution unit 103 may be implemented when the AI calculation unit performs calculations.

In an embodiment, a case has been described in which the information processing system 1 includes the processing server 10, the file server 20, and the OCR server 30. The information processing system 1 may include, in addition to these components, any other component as long as each of the functional units described with reference to FIG. 5 is implemented. In some examples, the information processing system 1 may be implemented by a single server or may be implemented within a user terminal 40.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing system, comprising:
a receiving unit configured to receive image information corresponding to a document from a user terminal;
an OCR execution unit configured to perform character recognition on the image information using optical character recognition (OCR);
a management unit configured to store definition data that defines a workflow associated with the image information;
an extraction unit configured to extract a usage item from the definition data of the workflow;
a correction candidate output unit configured to extract a value corresponding to the extracted usage item from a recognition result from the OCR execution unit and output the value as a correction candidate;
an accuracy information output unit configured to output information based on a recognition accuracy for the correction candidate; and
a correction acceptance unit configured to receive a correction of the correction candidate from the user terminal.

2. The information processing system according to claim 1, wherein the accuracy information output unit outputs a recognition accuracy value as a percentage.

3. The information processing system according to claim 1, wherein the accuracy information output unit causes the correction candidate to be displayed in an emphasized manner when the recognition accuracy for the correction candidate is lower than a first threshold value.

4. The information processing system according to claim 1, further comprising:
a confirmation request unit configured to output a confirmation request to the user terminal when the recognition accuracy associated with the correction candidate is lower than a second threshold value, the confirmation request requiring a user of the user terminal to input confirmation the correction candidate has been checked.

5. The information processing system according to claim 1, wherein the OCR execution unit extracts a keyword and a value corresponding to the keyword from the image information using AI technology.

6. The information processing system according to claim 1, wherein
the information based on the recognition accuracy is a recognition value indicating a calculated accuracy level, and
the recognition value is displayed with the correction candidate at the user terminal.

7. The information processing system according to claim 1, further comprises:
an undetected output unit configured to identify any extracted usage item without a corresponding value in the recognition result and output any so identified usage item to the user terminal; and
an undetected input acceptance unit configured to receive an input value from the user terminal for any extracted usage item without a corresponding value in the recognition result as identified by the undetected output unit.

8. An information processing system, comprising:
a processing server;
a file server; and
an OCR server, wherein
one or more processors of the processing server, the file server, and the OCR server execute software to implement:
a receiving unit configured to receive image information corresponding to a document from a user terminal via network;
an OCR execution unit configured to perform character recognition on the image information using optical character recognition (OCR);
a management unit configured to store definition data that defines a workflow associated with the image information;
an extraction unit configured to extract a usage item from the definition data of the workflow;
a correction candidate output unit configured to extract a value corresponding to the usage item from a recognition result from the OCR execution unit and output the value as a correction candidate;
an accuracy information output unit configured to output information based on a recognition accuracy for the correction candidate; and
a correction acceptance unit configured to receive a correction of the correction candidate from a user of the user terminal.

9. The information processing system according to claim 8, wherein the accuracy information output unit outputs a recognition accuracy value as a percentage.

10. The information processing system according to claim 8, wherein the accuracy information output unit causes the correction candidate to be displayed in an emphasized manner when the recognition accuracy for the correction candidate is lower than a first threshold value.

11. The information processing system according to claim 8, wherein the one or more processors further implement:
a confirmation request unit configured to output a confirmation request to the user terminal when the recognition accuracy associated with the correction candidate is lower than a second threshold value, the confirmation request requiring a user of the user terminal to input confirmation the correction candidate has been checked.

12. The information processing system according to claim 8, wherein the OCR execution unit extracts a keyword and a value corresponding to the keyword from the image information using AI technology.

13. The information processing system according to claim 8, wherein
the information based on the recognition accuracy is a recognition value indicating a calculated accuracy level, and
the recognition value is displayed with the correction candidate at the user terminal.

14. The information processing system according to claim 8, wherein the one or more processors further implement:
an undetected output unit configured to identify any extracted usage item without a corresponding value in the recognition result and output any so identified usage item to the user terminal; and
an undetected input acceptance unit configured to receive an input value from the user terminal for any extracted usage item without a corresponding value in the recognition result as identified by the undetected output unit.

15. A control method for an information processing system, the control method comprising:
receiving image information corresponding to a document from a user terminal;
performing character recognition on the image information using optical character recognition (OCR);
storing definition data that defines a workflow associated with the image information;
extracting a usage item from the definition data of the workflow;
extracting a value corresponding to the usage item from a recognition result of the OCR and outputting the value as a correction candidate to the user terminal;
outputting information based on a recognition accuracy for the correction candidate; and
receiving a correction of the correction candidate from the user terminal.

16. The control method according to claim 15, wherein the information based on the recognition accuracy for the correction candidate is a recognition accuracy value expressed as a percentage.

17. The control method according to claim 15, wherein the correction candidate is displayed in an emphasized manner when the recognition accuracy for the correction candidate is lower than a first threshold value.

18. The control method according to claim 15, further comprising:
outputting a confirmation request to the user terminal when the recognition accuracy associated with the correction candidate is lower than a second threshold value, the confirmation request requiring a user of the user terminal to input confirmation the correction candidate has been checked.

19. The control method according to claim 15, wherein the OCR extracts a keyword and a value corresponding to the keyword from the image information using AI technology.

20. The control method according to claim 15, wherein
the information based on the recognition accuracy is a recognition value indicating a calculated accuracy level, and
the recognition value is displayed with the correction candidate at the user terminal.
